(19) United States
(12) Patent Application Publication
(10) Pub. No.: US 2009/0027900 A1
(43) Pub. Date: Jan. 29, 2009

(54) POSITIONABLE OUTDOOR LIGHTING

(75) Inventors: Joseph John Janos, Wadsworth, OH (US); John Joseph Ascherl, Medina, OH (US)

Correspondence Address: CALFEE HALTER & GRISWOLD, LLP, 800 SUPERIOR AVENUE, SUITE 1400, CLEVELAND, OH, 44114, US

(73) Assignee: THE L.D. KICHLER CO., Cleveland, OH (US)

(21) Appl. No.: 11/931,052

(22) Filed: Oct. 31, 2007

Related U.S. Application Data
(60) Provisional application No. 60/863,691, filed on Oct. 31, 2006.

(51) Int. Cl. F21V 29/00; F21S 8/00

(52) U.S. Cl. 362/373; 362/421

(57) ABSTRACT

In one embodiment, a submersible LED lighting assembly is provided with at least one LED carried by a housing and thermally coupled to a heat sink carried by the housing to permit the submersible LED lighting assembly to be used in a dry environment. The exemplary lighting assembly is further provided with a water-tight light-transmitting member covering the at least one LED and cooperating with the housing to seal the at least one LED to permit the submersible LED lighting assembly to be used while immersed in water.

### CROSS REFERENCE TO RELATED APPLICATION

This application claims priority to, and any other benefit of, U.S. Provisional Patent Application Ser. No. 60/863,691, entitled POSITIONABLE OUTDOOR LIGHTING and filed Oct. 31, 2006, the entire disclosure of which is fully incorporated herein by reference.

### TECHNICAL FIELD

The present application relates generally to lighting fixtures and portables (collectively “lighting products”), and more particularly to a positionable lighting product for outdoor and landscaping applications, such as, for example, underwater applications.

### BACKGROUND

While outdoor lighting products utilizing incandescent light bulbs have been commercially available for decades, the nature of incandescent lighting may present limitations for certain outdoor applications, such as landscape lighting or underwater lighting, such as for pools, spas, and ponds. For example, a typical incandescent lighting fixture may be limited by a short service life, relatively high electrical current requirements, high heat generation, and a large size to obtain a desired level of illumination.

### SUMMARY

According to one inventive aspect of the present application, an exemplary submersible lighting assembly includes at least one LED carried by a housing and thermally coupled to a heat sink carried by the housing to permit the submersible LED lighting assembly to be used in a dry environment. The lighting assembly may also include a water-tight light-transmitting member covering the at least one LED and cooperating with the housing to seal the at least one LED to permit the submersible LED lighting assembly to be used while immersed in water.

According to another inventive aspect of the present application, an exemplary submersible LED lighting assembly includes a housing, a printed circuit board, a heat sink, and a light transmitting member. The housing includes an outer wall portion defining an internal cavity. The printed circuit board is disposed in the internal cavity and carries at least one LED. The at least one LED is thermally coupled to the heat sink. The heat sink is at least partially disposed in the cavity of the housing. The light-transmitting member covers at least a portion of the printed circuit board carrying the at least one LED. The light-transmitting member cooperates with at least the housing and the heat sink to seal the at least one LED to permit the submersible LED lighting assembly to be used while immersed in water. The housing further includes at least one opening permitting water to contact the heat sink.

According to yet another inventive aspect of the present application, an exemplary LED lighting assembly includes a housing, a printed circuit board, and a light-transmitting member. The housing includes an outer wall portion defining an internal cavity and a plurality of projections extending outwardly from an outer surface of the outer wall portion. The printed circuit board is disposed in the internal cavity, and carries at least one LED. The at least one LED is thermally coupled to the housing. The light-transmitting member covers at least a portion of the printed circuit board carrying the at least one LED. At least a portion of the outer wall portion and the plurality of projections include a thermally conductive material to function as a heat sink to permit the LED lighting assembly to be used in a dry environment.

According to still another embodiment of the present application, an exemplary mountable lighting assembly includes a housing, a light source, a ball member, a mounting member, and a ball retaining member. The housing includes a base portion and an outer wall portion extending from the base portion to define an internal cavity. The light source is disposed in the internal cavity. The ball member comprises a stem portion connected with the base portion of the housing and a ball portion extending from the stem portion, the ball portion having a spherical outer surface. The mounting member is adapted to be affixed to a mounting surface, and includes an opening through which the stem portion extends, and a first spherical socket surface surrounding the opening and engaging the spherical outer surface of the ball member. The ball retaining member is assembled with the mounting member to secure the ball member therebetween. The ball retaining member includes a second spherical socket surface engaging the spherical outer surface of the ball member. The ball portion and the first and second spherical socket surfaces provide a ball and socket connection for adjusting the orientation of the light source.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below, serve to exemplify the principles of this invention, wherein:

FIG. 1 is a cross-sectional side schematic view of an exemplary lighting assembly;

FIG. 2 is a cross-sectional side schematic view of another exemplary lighting assembly;

FIG. 3 is an exploded perspective view of the lighting assembly of FIG. 2;

FIG. 4 is an exploded side perspective view of an exemplary lighting assembly;

FIG. 5 is an exploded rear perspective view of the lighting assembly of FIG. 4;

FIG. 6 is a side schematic view of another exemplary lighting assembly;

FIG. 7 is an exploded side perspective view of the lighting assembly of FIG. 6;

FIG. 8 is a top view of the lighting assembly of FIG. 6;

FIG. 9 is an exploded side perspective view of another exemplary lighting assembly;

FIG. 10A is a schematic view of an exemplary outdoor lighting system wired in series;

FIG. 10B is a schematic view of an exemplary outdoor lighting system wired in parallel;

FIG. 10C is a wiring schematic for an exemplary LED lighting product;

FIG. 11 is an exploded side perspective view of a positionable flange mount for a lighting assembly;

FIG. 12 is an exploded top perspective view of the positionable mount of FIG. 11;

FIG. 13 is an exploded bottom perspective view of the positionable mount of FIG. 11;

FIG. 14 is a perspective view of a ball member for a positionable mount;

FIG. 15 is a side perspective view of an exemplary lighting assembly with an exemplary positionable flange mount;

FIG. 16 is a side view of the lighting assembly of FIG. 15;

FIG. 17 is a top perspective view of the lighting assembly of FIG. 15;

FIG. 18 is a bottom perspective view of the lighting assembly of FIG. 15;

FIG. 19 is a second bottom perspective view of the lighting assembly of FIG. 15;

FIG. 20 is an exploded side perspective view of an exemplary positionable flange and stake mount for a lighting assembly;

FIG. 21 is an exploded top perspective view of the positionable mount of FIG. 20;

FIG. 22 is an exploded bottom perspective view of the positionable mount of FIG. 20;

FIG. 23 is a side perspective view of an exemplary lighting assembly with an exemplary positionable flange and stake mount;

FIG. 24 is a top perspective view of the lighting assembly of FIG. 23;

FIG. 25 is a bottom perspective view of the lighting assembly of FIG. 23;

FIG. 26 is a perspective view of another exemplary lighting assembly with an exemplary outer rim adapted to receive accessory attachments;

FIG. 27 is a perspective view of a removable lens for attachment with a lighting assembly; and

FIG. 28 is a perspective view of a removable cowl for attachment with a lighting assembly;

FIG. 29 is a perspective view of a removable weighted member for attachment with a lighting assembly; and

FIG. 30 is a partially exploded perspective view of a lighting assembly with the weighted member of FIG. 29.

### DETAILED DESCRIPTION

The present invention is directed toward positionable lighting fixtures and portables (“lighting products”). Exemplary embodiments include, for example lighting fixtures and portables having light emitting diode (LED) light sources, submersible LED lighting products, dry service LED lighting products, and mountable lighting products having ball and socket arrangements for adjusting the position or direction of a light source.

According to one inventive aspect of the present application, an outdoor lighting product may be provided with a light emitting diode (LED) light source, which may provide any one or more of several advantages over other light sources, such as, for example, incandescent light bulbs. For example, an LED light source may provide greater illumination from a smaller lighting product. The small size of the LEDs provides adaptability in light intensity, as adding additional LEDs to a lighting assembly will typically have a negligible effect on the total size of the assembly. As another example, an LED light source may produce illumination more efficiently, generating as much as 55 lumens per watt, compared to 10-12 lumens per watt for an incandescent bulb. This reduced power consumption may also make the LED lighting product safer for some outdoor uses, such as applications in which the assembly is submerged or exposed to moisture. As still another example, an LED light source may enjoy a service life that is 30 to 100 times that of a standard incandescent, fluorescent, or halogen light bulb, in many cases lasting for decades in a non-continuous use application. Further, continuing advances in LED technology will only improve LED efficiency, light intensity, and service life in the future.

The service life of an LED based light source may be limited by the temperatures to which the LED is exposed. If the heat generated by the illuminated LEDs is not permitted to dissipate, the resulting elevated temperatures may reduce the service life of the LEDs substantially. To reduce temperatures at the LEDs, a heat sink may be provided to draw heat away from the LEDs. A heat sink generally includes a component constructed of a thermally conductive material and thermally coupled to the LED to absorb heat generated by the LED. In one embodiment, a heat sink may be provided with one or more fins, prongs, flanges, or other projections configured to draw generated heat further away from the LED. In another embodiment, the heat sink may additionally or alternatively be exposed to a cooling medium, such as a liquid or gas, which absorbs the generated heat and carries the heat away from the lighting product to maintain a reduced temperature at the LED. As one example, in an underwater application, exposure of the heat sink to the water may serve to assist in drawing heat from the heat sink and away from the LED. The heat sink may be carried by (e.g., integral with, attached to, or assembled with) a housing of the lighting product, and may be fully or partially disposed within a cavity of the housing.

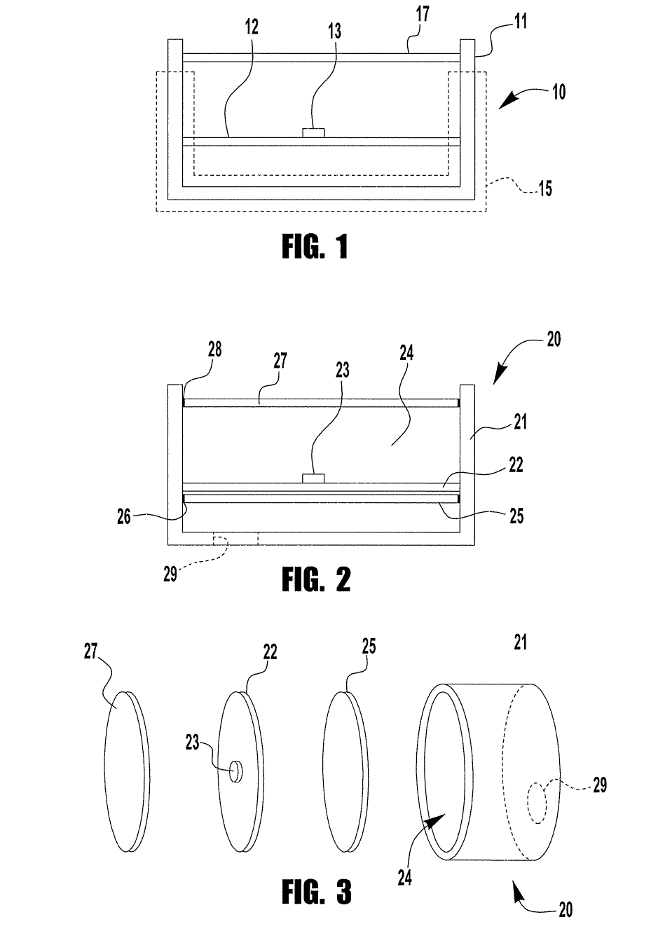

Referring now to the drawings, FIG. 1 is a schematic illustration of an exemplary lighting product 10 configured to be used in both submersible (underwater) applications and in dry service applications, such as indoor applications or dry landscaping applications. The exemplary lighting product 10 includes a housing 11 configured to carry at least one LED 13. The LED 13 is thermally coupled with a heat sink carried by the housing, shown in phantom at 15, which may be separate from or integral with the housing 11. The heat sink 15 may be provided in a thermally conductive material, including, for example, metals such as aluminum or brass. To adequately draw heat away from the illuminated LED 13, the heat sink 15 may extend beyond an outer surface of the housing 11. This extension of the heat sink 15 may include, e.g., fins, ribs, or other such projections, examples of which are described in greater detail below. By extending the heat sink 15 as described, the heat sink 15 may be able to sufficiently draw heat from the illuminated LED 13 and radiate that heat away without the need for exposure to a separate cooling medium, thereby increasing the service life of the LED 13 in applications in which a cooling medium is unavailable, such as in dry outdoor landscaping applications, particularly in warmer climates.

While the LED 13 may be coupled with the heat sink 15 in many different ways, in the exemplary lighting product, the LED 13 is thermally coupled to the heat sink 15 through a circuit board 12 to which the LED 13 is electrically connected. The circuit board 12, in turn, is in thermal communication with the heat sink 15, such as by being in direct or indirect contact with the heat sink 15.

The exemplary lighting product 10 is further provided with a light-transmitting member 17 assembled with the housing 11 to cover the LED 13. As described herein, light transmitting members for lighting products may serve one or more of many different functions, including, for example, protection of the light source from dirt, moisture, or impact, prevention of exposure of foreign objection to the (often high temperature) light source, improvement of aesthetic appearance of the lighting product, and alteration of the generated light, such as by filtering, directing, partial blocking, or changing color. Any of the lighting products herein may include any number of light transmitting members, for example, to serve multiple functions. As one example (not shown), a lighting product may include internal parabolic lenses to direct the light emitted by the LEDs, as well as an exterior light transmitting member or lens to protect the LEDs and internal lenses. The exemplary light-transmitting member 17 is provided in a transparent or translucent material, such that light generated by the LED 13 is emitted through the light-transmitting member 17 to provide illumination from the lighting product 10. The light-transmitting member may be provided from many different materials, such as, for example, glass and plastic. A water-tight seal 18 may be provided between the light-transmitting member 17 and the housing 11 to keep water or moisture away from the LED 13 and the circuit board 12. The seal 18 may include many different types of components or materials, including for example, gasket-type seals, such as O-rings, or sealant compounds, such as silicone (for example room-temperature vulcanizing, or RTV, silicone).

Power may be supplied to the LED of the exemplary lighting product 10 using one or more of many different mechanisms (not shown), including, for example, electrical wiring in communication with an external power source, batteries disposed within the housing, or solar power cells.

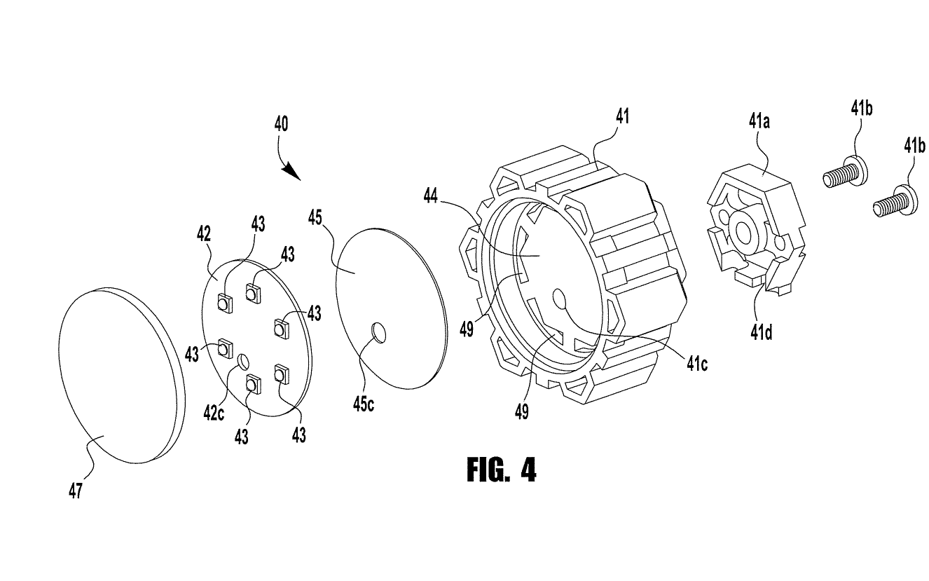

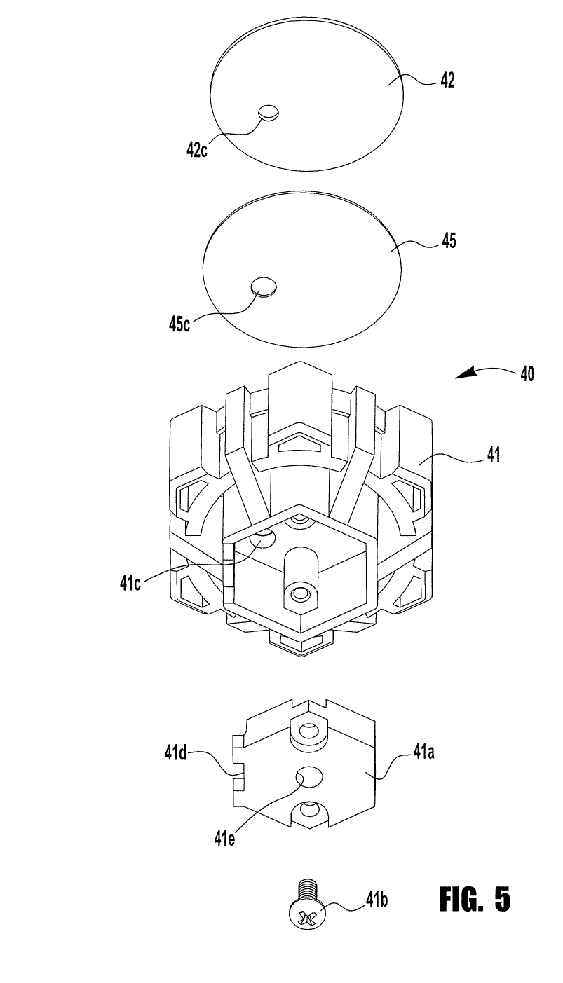

FIGS. 2 and 3 are schematic illustrations of another exemplary lighting product 20 configured to be used in submersible (underwater) applications. As with the lighting product 10 of FIG. 1, this exemplary lighting product 20 includes a housing 21, at least one LED 23 carried on a circuit board 22, a heat sink 25, and a light-transmitting member 27. The housing 21 includes an outer wall portion that defines an internal cavity 24 in which the circuit board 22 and LED 23 are disposed. The light-transmitting member 27 seals with the outer wall of the housing 21 at seal 28 to prevent exposure of the circuit board 22 and LED 23 to water. The exemplary heat sink 25 comprises a disc of thermally conductive material disposed between the circuit board 22 and the base of the housing 21. The LED 23 may be thermally coupled with the heat sink 25, such as by direct or indirect contact between the circuit board 22 and the heat sink 25. In one embodiment, the circuit board 22 may be directly bonded to the heat sink 25, such as with a thermal adhesive.

In order to reduce the required size of the heat sink 25, to reduce or eliminate the need for heat absorbing projections extending from the heat sink 25, or to allow for the use of non-thermally conductive housing materials, such as plastics, the lighting product 20 may be configured to allow for exposure of the heat sink 25 to a cooling medium, such as, for example, the water in which a submersible lighting product 20 is submerged. In one embodiment, a heat sink may form an outer portion of the housing, such that this heat sink portion of the housing would be exposed to water when the lighting product is submerged. In another embodiment, a heat sink may include one or more portions that extend through openings in the housing to contact the fluid in which the lighting product is submerged. In still another embodiment, one or more openings may be provided in the housing to allow a cooling medium to contact the heat sink disposed within the housing.

In the illustrated embodiment of FIGS. 2 and 3, the housing 21 includes an opening 29 in fluid communication with the heat sink 25, such that the opening 29 permits water to contact the heat sink 25 of the submerged lighting product 20. To prevent water entering the opening 29 from reaching the circuit board 22 and LED 23, a water-tight seal 26 may be provided between the heat sink 25 and the housing 21. While many different sealing components and materials may be used, a thermal adhesive may provide sufficient thermal resistance to withstand extreme temperatures of the heat sink 25. Examples of suitable thermal adhesives include double sided tape style thermal adhesives (for example Bond-Ply 100, manufactured by Bergquist Co.) or paste style thermal adhesives (for example, TT011, manufactured by TennRich Co.).

FIGS. 4 and 5 are exploded views of an exemplary LED lighting product 40, which may be used, for example, in submersible or underwater applications. As with the schematically illustrated lighting product 20 of FIGS. 2 and 3, the housing 41 defines a cavity 44 in which a heat sink disk 45 and circuit board 42 are disposed. The circuit board 42 carries, and is electrically connected with, one or more LEDs 43. A light-transmitting member 47 is sealed against a counter-bore in the housing 41, such as with a silicone sealant, to provide a water-tight seal above the circuit board 42. The light-transmitting member 47 may be provided in a transparent or translucent material, such as glass or plastic, at least in the areas covering the LEDs 43. As shown in FIG. 4, the housing 41 may be provided with one or more openings 49 extending from the cavity 44 to an outer surface of the housing 41 to allow water to enter the housing 41 and contact the heat sink 45, to draw away heat absorbed by the heat sink 45 from the LEDs 43. The heat sink may be bonded with the circuit board and sealed with the housing 41 using a sealant or adhesive, such as a thermal adhesive, thereby preventing the circuit board 42 and LEDs 43 from being exposed to water contacting the heat sink 45. The housing 41 may (i.e., might, but need not) be provided in a non-thermally conductive material (e.g., plastic), as the thermally conductive heat sink 45, when exposed to water or some other cooling medium, is sufficient to absorb heat from the illuminated LEDs 43 and maintain the LEDs at a preferred temperature, such as a temperature that enables an extended service life.

To supply power to the exemplary lighting product 40, electrical wiring (not shown), such as, for example, #18 gage direct burial wire, may be used to connect the circuit board 42 to an external power source, such as a transformer. A separate housing back 41a may be attached to the housing 41 using, for example, machine screws 41b. The housing back 41a may, for example, provide strain relief for the wiring passing from the circuit board through the housing, or to provide a mounting interface, such as a threaded hole 41e, to assemble the lighting product 40 to a mounting member, such as a flange or stake. Aligned openings 42c, 45c, 41c, 41d may be provided in the circuit board 42, heat sink 45, housing 41, and housing back 41a to accommodate the electrical wiring. A potting material (not shown), such as, for example, an epoxy, may be applied to the housing 41 and/or housing back 41a to provide a water resistant seal. Further a sealant, such as silicone based RTV sealant, may be applied around the wiring to prevent liquid potting from leaking out of the housing until the potting is cured. While the wiring from the circuit board may be sized and configured to extend to a power source, in another embodiment, shorter leads from the circuit board may instead be provided, with the ends of the leads soldered and potted with the ends of wiring for assembly with a power source.

In selecting material for constructing a lighting product, many different factors may be considered to provide the desired appearance, cost of manufacturing, system compatibility, and other factors. For example, for underwater use in ponds including live fish, the use of materials harmful to fish, such as, for example, copper and copper derivatives, may be avoided. While many different suitable materials may be used in constructing the exemplary lighting product 40, in one exemplary embodiment, the housing 41 and housing back 41a are provided in plastic, e.g., polycarbonate, the heat sink disk 45 is provided in metal, e.g., stainless steel, and the light-transmitting member is provided in glass, e.g., non-tempered glass. The circuit board 42 may (i.e., might, but need not) be a metal core circuit board, which may provide improved thermal conductivity for dissipating generated heat to the heat sink 45. Additionally, the circuit board 42 may be covered with potting, for example, to provide a water resistant seal for the circuit board, or to provide protection from ultraviolet (UV) light for the circuit board. As one example, the potting material may include a silicone-based compound. The silicone based potting material may protect the circuit board from up to 100% of UV rays. Further, the silicone based potting material may flex to allow for reduction of stresses, for example, at solder points for surface mount components of the circuit board, resulting from thermal expansion and contraction of the circuit board components caused by changes in temperature. The potting compound may be applied to cover the circuit board without covering the LEDs 43, so as to not affect illumination of the LEDs.

Unlike a submerged or underwater LED lighting product, in which the water serves as a cooling medium to assist the heat sink in drawing heat away from the LEDs, a dry application, such as a landscape lighting application, may require a heat sink that is configured to absorb heat from the LEDs, and maintain a reduced temperature at the LEDs, without the aid of a cooling medium. This may be accomplished, for example, by increasing the surface area of the heat sink to improve thermal transfer between the heat sink and the surrounding environment, by increasing the mass of the heat sink, or by extending portions of the heat sink further away from the source of the heat (i.e., the LEDs). In one embodiment, a thermally conductive heat sink may be provided with one or more fins, ribs, flanges, or other such projections that effectively draw heat further away from heat-producing illuminated LEDs to which the heat sink is thermally coupled. As one example, an LED lighting product may be provided with a thermally conductive housing that includes one or more projections extending outward from an outer surface of the housing. One or more LEDs in the product may be thermally coupled with the housing, such that the housing functions as a heat sink effective in drawing heat away from the LEDs and toward the one or more projections.

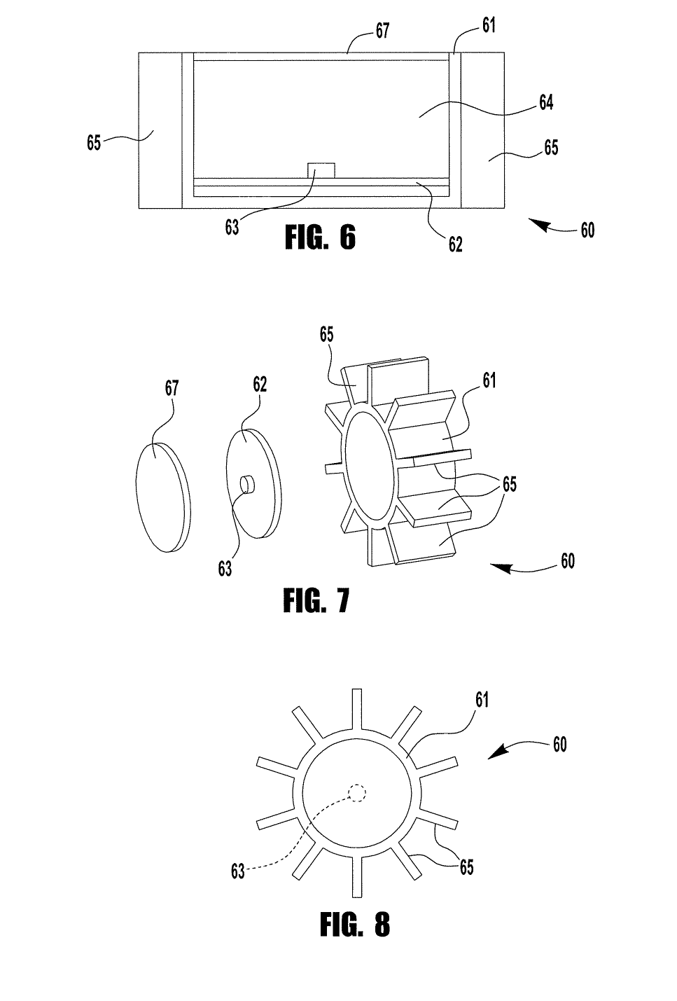

FIGS. 6, 7, 8 are schematic illustrations of an exemplary lighting product 60 for use in dry applications, such as, for example, landscape lighting applications. The exemplary lighting product 60 includes a housing 61 defining a cavity 64 in which a circuit board 62 carrying one or more LEDs 63 is disposed. A light-illuminating member 67 covers at least a portion of the circuit board 62. As the lighting product 60 is adapted for use in dry applications, the light-illuminating member need not, but may, be provided with a water tight seal (not shown here; examples shown in FIGS. 1 and 2) for sealing against the housing 61.

At least a portion of the housing 61 of the exemplary lighting product 60 is provided in a thermally conductive material, such as one of many suitable metals, including stainless steel, aluminum, and brass. The housing 61 is thermally coupled with the circuit board 62, such that the housing 61 functions as a heat sink, capable of drawing heat generated by the LEDs 63 away from the LEDs, such that the service life of the LEDs is not significantly reduced due to exposure to elevated temperatures.

In one embodiment, an LED lighting product having a thermally conductive housing that acts as a heat sink may be adapted to be used in underwater applications, such as by providing water-tight seals on the external surfaces of the lighting product. In such an embodiment, the shape and/or size of the housing may not need to be adapted to better function as a heat sink, since water contacting the external surfaces of the submerged housing may draw sufficient heat away from the housing, such that a proper temperature is maintained at the LEDs. However, in applications where an LED lighting product is not submerged in water or exposed to some other cooling medium, the housing/heat sink may be adapted to better draw heat away from the LEDs, such as by providing one or more projections extending from an outer surface of the housing. In the illustrated embodiment of FIGS. 6, 7, and 8, a plurality of projections 65 extend from an outer surface of the housing 61 to draw heat away from the LED 63. The projections 65 may be integral with the housing 61, or they may be one or more separate thermally conductive components attached with the housing 61. While the projections 65 of the schematically illustrated lighting product are shown as a series of ten narrow ribs evenly spaced around the outer circumference of the exemplary housing 61, it should be understood that the housing/heat sink projections 65 may be provided in many different shapes, sizes, quantities, and orientations on the housing 61, to provide effective heat sink properties for the exemplary lighting product 60.

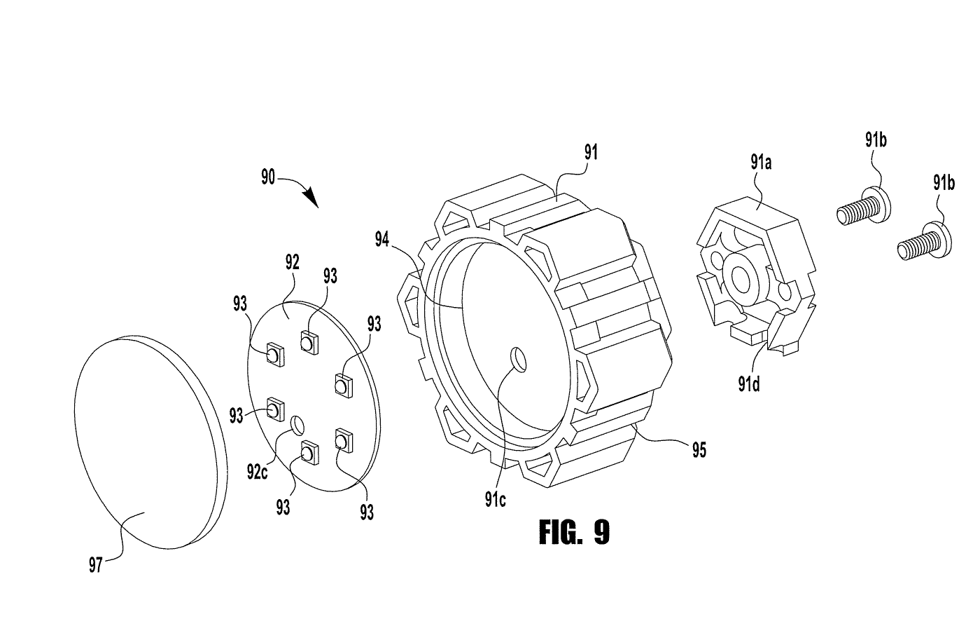

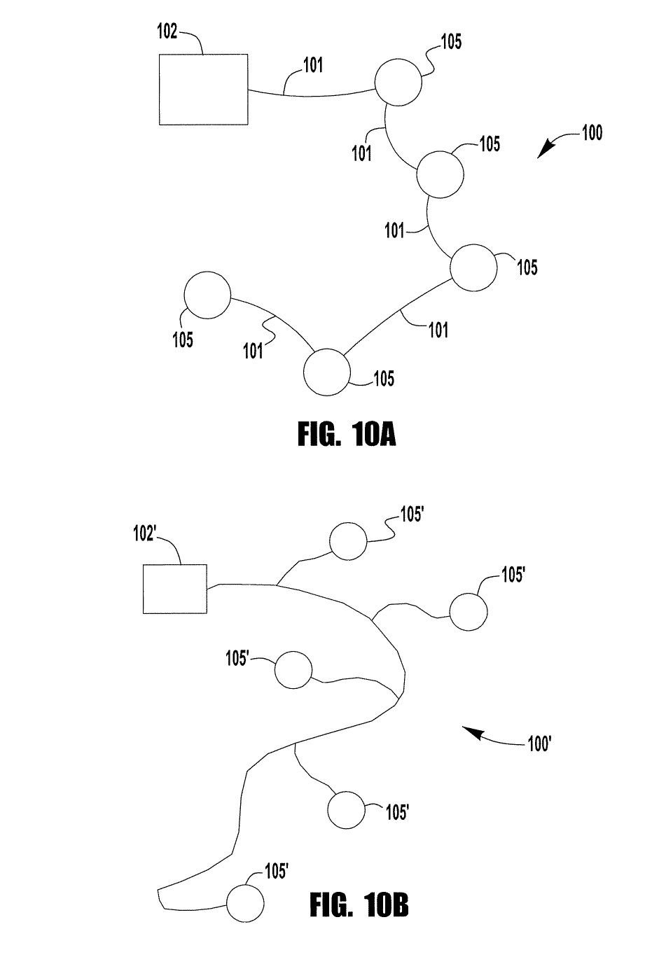

FIG. 9 is an exploded view of an exemplary LED lighting product 90, which may be used, for example, in a dry outdoor landscaping application. The exemplary lighting product 90 includes a thermally conductive housing 91 that defines a cavity 94 in which a circuit board 92 is disposed. The circuit board 92 carries, and is electrically connected with, one or more LEDs 93. A light-transmitting member 97 is assembled with the housing 91. The light-transmitting member 97 may be provided in a transparent or translucent material, such as glass or plastic, at least in the areas covering the LEDs 93. For use of the lighting product 90 in dry environments, the light-illuminating member need not, but may, be provided with a water tight seal (not shown) for sealing against the housing 91.

As with the schematically illustrated lighting product 60 of FIGS. 6, 7, and 8, the lighting product 90 of FIG. 9 may utilize the housing 91 as a heat sink for dissipating heat generated by the LEDs 93. As such, the circuit board 92 may be thermally coupled to the housing 91, such as by being in direct or indirect contact with the thermally conductive housing 91. The housing is provided with a series of projections 95 extending from an outer surface of the housing 91. The exemplary projections 95 include radially extending ribs 95a and hollow corners 95b positioned around the circumference of the housing 91. These outward projections 95 are configured to draw heat further away from the LEDs 93. Additionally, the projections may be shaped to form engageable surfaces configured to improve durability, impact resistance, positionability, or other such advantages. In the exemplary embodiment, the projections 95 extend from the housing 91 to form facets of a polygon (e.g., a regular polygon having between 5 and 10 sides), which may provide additional advantages, such as, for example, making the projections sturdier and less likely to break off, providing strong weight bearing surfaces for wedging the lighting product into various locations, such as between rocks, and providing flat side surfaces to facilitate positioning the lighting product 90 in a desired orientation. For these and other additional advantages, the exemplary projections or other such projections may be provided with lighting products that do not use the housing as a primary heat sink, such as, for example, the exemplary submersible lighting product 40 of FIGS. 4 and 5.

While many different materials may be used in constructing the exemplary lighting product 90 in one exemplary embodiment, the thermally conductive housing 91 is provided in an anodized aluminum, the housing back 41a is provided in polycarbonate, and the light-transmitting member is provided in non-tempered glass. Additionally, the circuit board 42 may be covered with potting, as described above, to seal the circuit board from water or moisture and/or to protect the circuit board from UV radiation.

To supply power to the exemplary lighting product 90, electrical wiring (not shown), such as, for example, #18 gage direct burial wire, may be used to connect the circuit board 92 to an external power source, such as a transformer. As the circuit board may reach elevated temperatures, high temperature rated electrical wiring may be desired. A separate housing back 91a may be attached to the housing 91 using, for example, machine screws 91b, which may, for example, provide strain relief for the electrical wiring or provide a mounting interface, such as a threaded hole 91e, to assemble the lighting product 90 to a mounting member, such as a flange or stake. Aligned openings 92c, 95c, 91c, 91d may be provided in the circuit board 92, heat sink 95, housing 91, and housing back 9 to accommodate the electrical wiring. A potting material (not shown), such as, for example, an epoxy, may be applied to the housing 91 and/or housing back 91a to provide a water resistant seal around the wiring. While the wiring from the circuit board may be sized and configured to extend to a power source, in another embodiment, shorter leads from the circuit board may instead be provided, with the ends of the leads soldered and potted with the ends of wiring for assembly with a power source.

Many different arrangements may be used to provide an outdoor lighting system having one or more LED lighting products. In one embodiment, each lighting product or component may be separately powered, such as by a battery or solar cell. In another embodiment, an outdoor lighting system may include multiple lighting products wired to a transformer or other power source individually, or together in series or in parallel, or any suitable wiring arrangement, such that only one power source is required to power a system or network of lighting products.

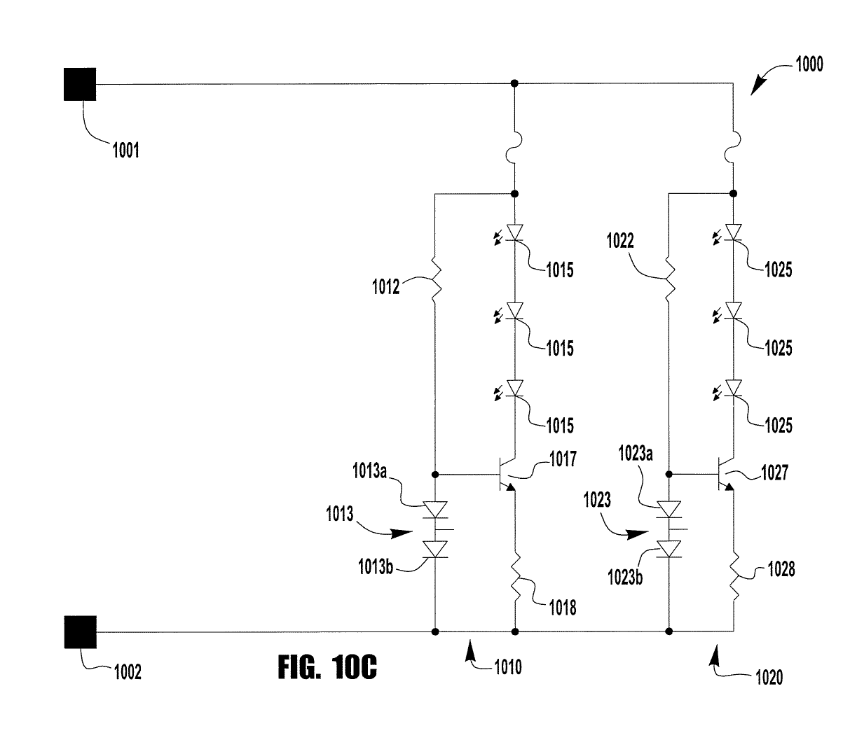

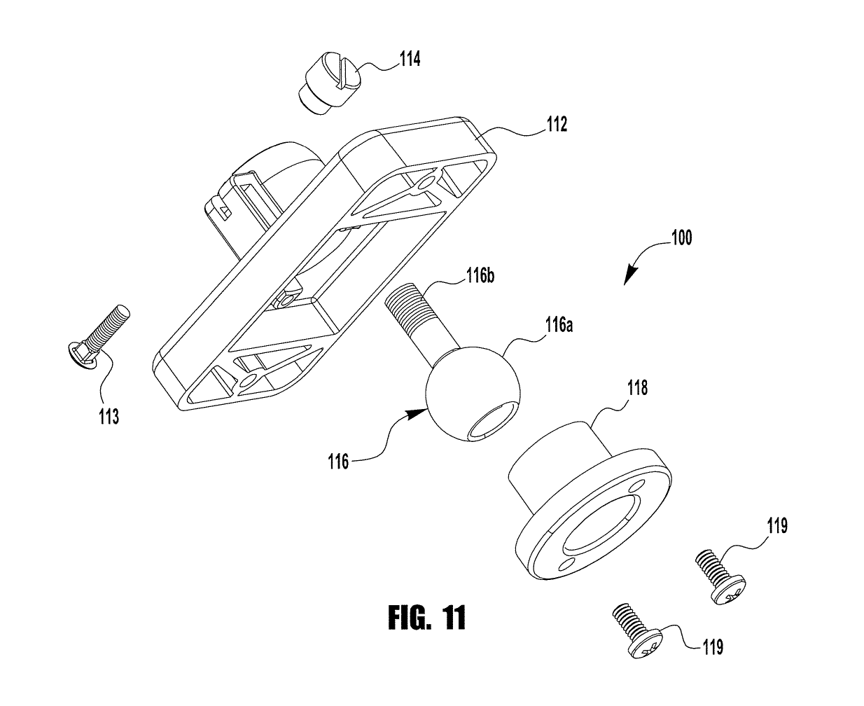

FIGS. 10A and 10B are schematic illustrations of exemplary lighting systems 100, 100′ in which several lighting products 105, 105′ are wired together for connection with a power source 102, 102′, such as a transformer. As one example, the power source 102, 102′ may include a “control gear” type (or electronic switching) power supply, which may, for example, be driven from any suitable AC landscape transformer. The power supply may convert from AC to DC voltage for operation of the LEDs. In one embodiment, an exemplary “control gear” type power supply may power up to ten LED lighting products. In the illustrated schematic of FIG. 10A, electrical wiring 101 connects the lighting products 105 in series with the power source 102, which limits the amount of wiring 101 required to power all of the lighting products 105, compared to, for example, individually wiring each lighting product 105 to the power source 102. In the illustrated schematic of FIG. 10B, the lighting products 105′ are wired in parallel with the power source 102′, such that a malfunction or other such electrical interruption at one of the lighting products will not affect power supply to the remaining lighting products. In another exemplary embodiment, an electrical hub, connected with a power source, may provide electrical connections for several lighting products, with ports connected in parallel to supply power to the lighting products connected with the ports. An example of such an electrical hub is described in U.S. Provisional Patent Application Ser. No. 60/741,404, filed Nov. 30, 2005, entitled “Subterranean Electrical Hub,” which is hereby incorporated by reference in its entirety.

To electrically power the LEDs 93 connected with the circuit board 92 in an exemplary lighting product 90, such as, for example, the lighting product 90 of FIG. 9, many different circuit arrangements may be utilized. In one embodiment, the circuit board may employ a current regulating circuit designed to drive the LEDs at a desired current, such as the manufacturer recommended current, based on a defined input power range that will be supplied to the lighting product 90. Further, the circuit board 92 may include circuitry that divides the connected LEDs into multiple independent circuits. As one example, a circuit board 92 connected with six LEDs may include two independent circuits with each circuit providing electrical connectivity for three LEDs. This arrangement may, for example, provide for more evenly distributed heat generation on the circuit board, preventing excessive temperatures at LEDs positioned proximate to heat generating circuit components. This multiple circuit arrangement may further be provided with a built-in fuse associated with each circuit, such that failure of one LED will not effect LEDs connected to the other circuits.

FIG. 10C illustrates an exemplary wiring arrangement 1000 for a circuit board for use with an LED lighting product powered by an external “control gear” type power supply. The exemplary wiring arrangement 1000 includes two independent circuits 1010, 1020 arranged in parallel between power connections 1001, 1002. Each circuit includes three LEDs 1015, 1025. To provide consistent light intensity, both within the lighting product (among the six LEDs 1015, 1025) and within a lighting system including several LED lighting products, the circuits 1010, 1020 may be configured to provide a controlled current through the LEDs 1015, 1025 regardless of minor changes in the input voltage to the lighting product. Resistors 1012, 1022 establish current flow through switching diodes 1013, 1023, which allows for a substantially fixed voltage across the switching diodes 1013, 1023 to act as a reference for transistors 1017, 1027. Each of the switching diodes 1013, 1023 contains two diodes—upper and lower—in series. The voltage drops across the upper diodes 1013a, 1023a will match the voltage drop across a base-emitter diode of each transistor 1017, 1027. The voltage drops across the lower diodes 1013b, 1023b become a reference that the transistors 1017, 1027 use to control current through resistors 1018, 1028. The resulting voltage drops across the resistors 1018, 1028 are made to match the reference voltage by corresponding voltage gains of the transistors 1017, 1027. Further, each circuit 1010, 1020 may be provided with a fuse 1019, 1029 to protect the other of the two circuits if a failure should occur with a component in the circuit. While any suitable parameters may be used for the circuit components, in one embodiment, resistors 1012, 1012 may be provided with a resistance of 1200 ohms, resistors 1018, 1028 may be provided with a resistance of 4750 ohms, to produce a current of 147 mA through the LEDs 1015, 1025, where a voltage of 0.7 VDC is supplied to the lighting product.

By using a “control gear” type power supply and current regulating circuit, as described above, a lighting system fabricator may control the desired power to each lighting product, taking into consideration lighting product parameters, such as those of the electrical wiring and LED circuits. This may provide a simpler and less expensive LED driver system, as compared to installing a driver, such as an IC based driver, in each lighting product. Additional advantages of using an external driver may include, for example, a reduced package size for each lighting product, improved heat management within the lighting product, and protection of the driver from possible exposure to water when the lighting product is used under water.

Any of the above described outdoor lighting products, as well as other such lighting products not described, may be positioned or mounted in a variety of ways for outdoor use, such as for underwater use in ponds, pools, or spas, or for use as landscaping lights, such as detail or accent lights to highlight various landscaping features. In one embodiment, a lighting product with a compact housing may be loosely placed in a desired location, embedded in loose stone or soil, or wedged between any number of rocks, structures, or foliage. The shape and size of the lighting product housing may be adapted to accommodate this type of positionability. In another embodiment, the outdoor lighting product may be provided with one or more mounting members, such as a flange for mounting with fasteners to a wall or similar structure, or a stake for embedding in the ground. The mounting member may be connected with or integral to a housing in which the light source is disposed. The use of such a mounting member may provide for more permanent fixation of the lighting product, as well as improved placement of the emitted light. In still another embodiment, a positionable outdoor lighting product may include a housing connected to a mounting member by an adjustable joint or connection, such that the mounted lighting product may be positioned or adjusted to direct emitted light in a desired direction, such as towards a landscaping feature (e.g., fountains or foliage).

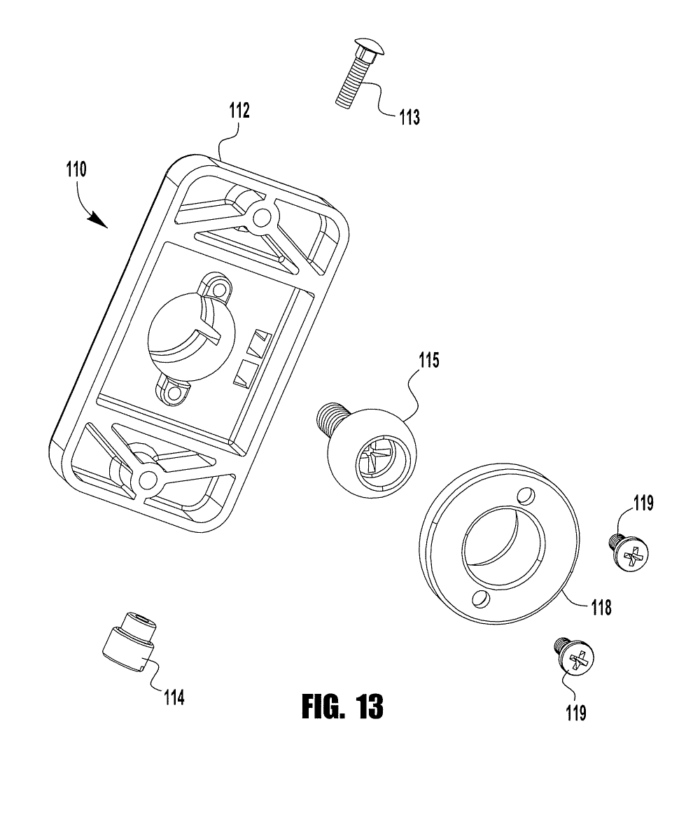

FIGS. 11-14 illustrate one exemplary embodiment of a mounting arrangement or accessory 110 for a lighting product, such as, for example, the lighting products of FIGS. 1-9. It should be noted that while the illustrated and described embodiments are of LED based lighting products, the inventive aspects of the exemplary mounting arrangement may also be used with other types of lighting products, such as, for example, incandescent, fluorescent, and halogen lighting products, as well as other mountable devices, such as, for example, speakers and video monitoring equipment.

The exemplary mounting arrangement 110 includes a mounting member or flange 112, a ball member 116 and a ball retainer 118. The exemplary ball member 116 includes a stem portion 116b sized to extend through an opening in the flange 112, and a ball portion 116a configured to be disposed between the flange 112 and the ball retainer 118. The ball retainer 118 may be assembled with the flange 112 using fasteners, such as machine screws 119. The flange 112 may be configured to be mounted to a structure (e.g., a wall, deck, or post). As one example, the flange 112 may include mounting holes 111 positioned to receive fasteners therethrough for affixing the flange 112 to the structure.

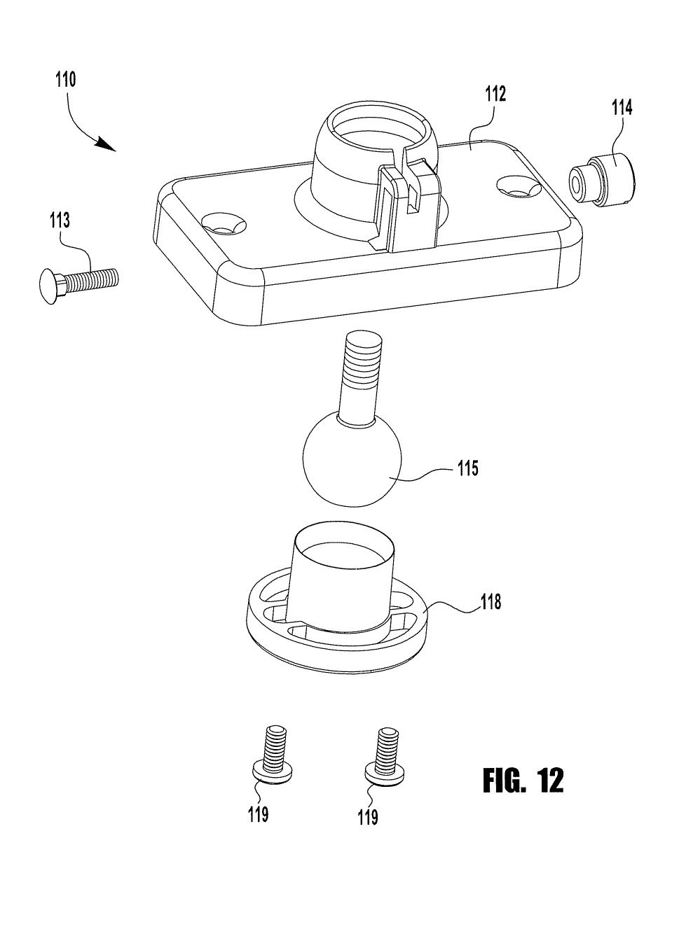

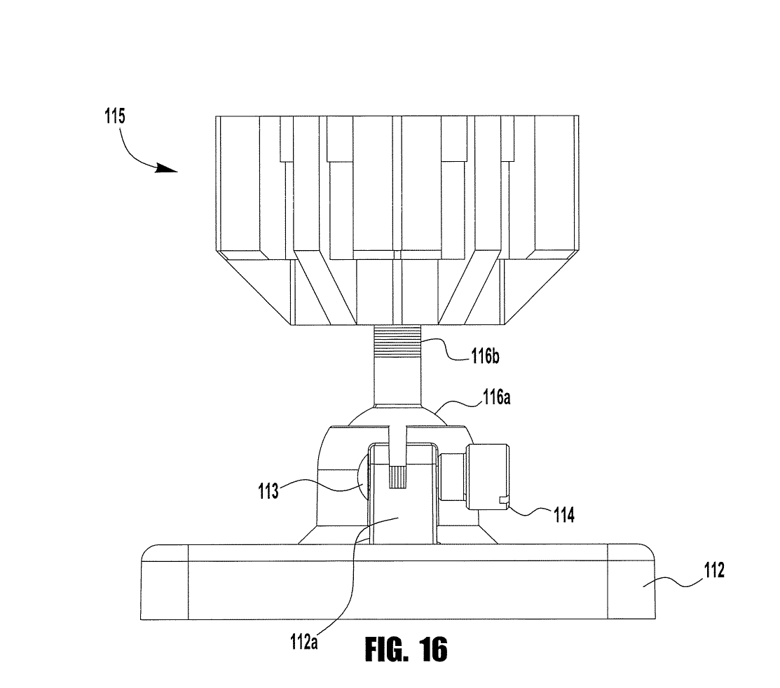

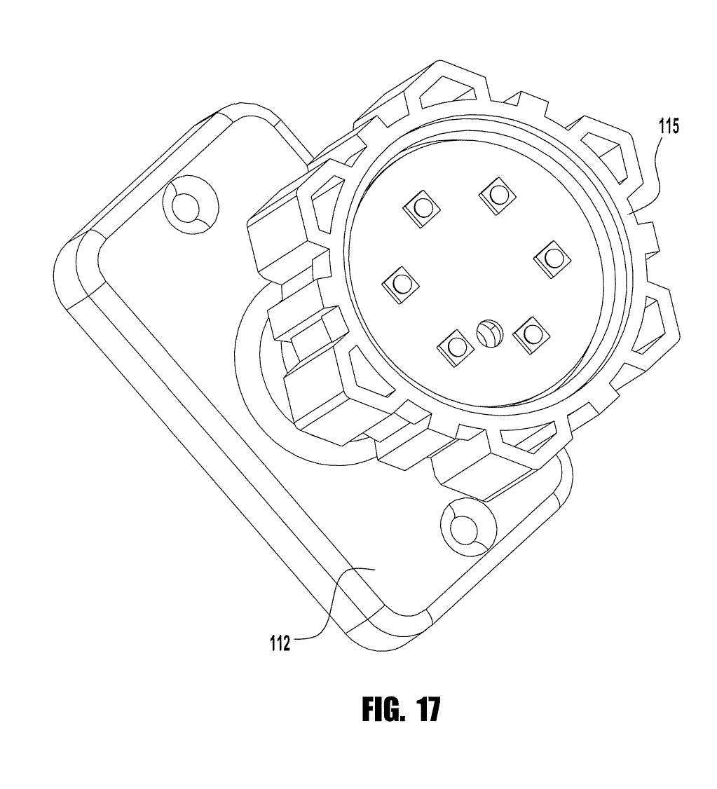

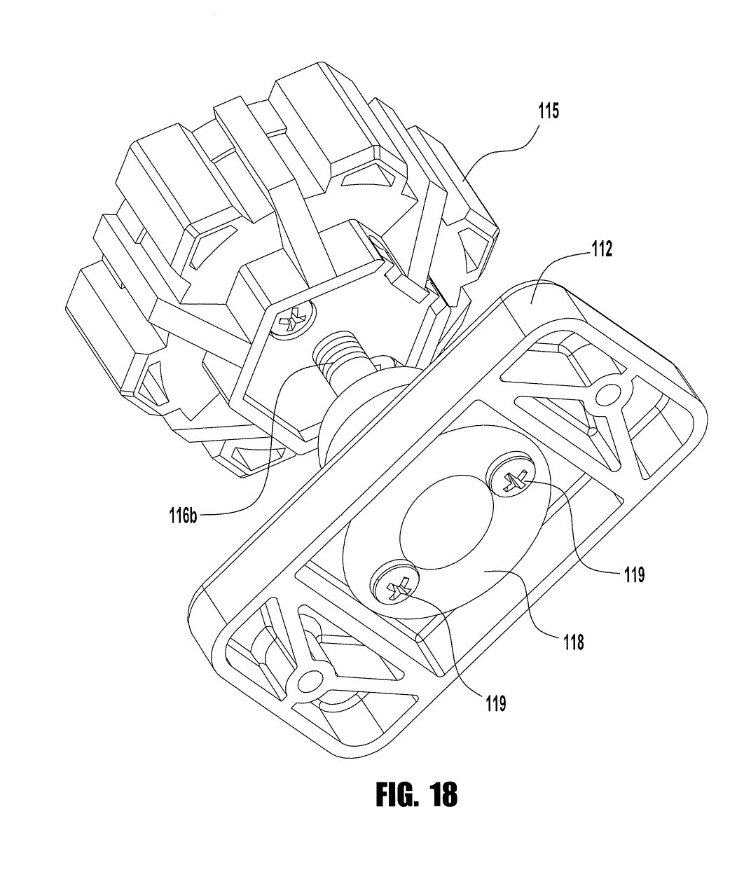

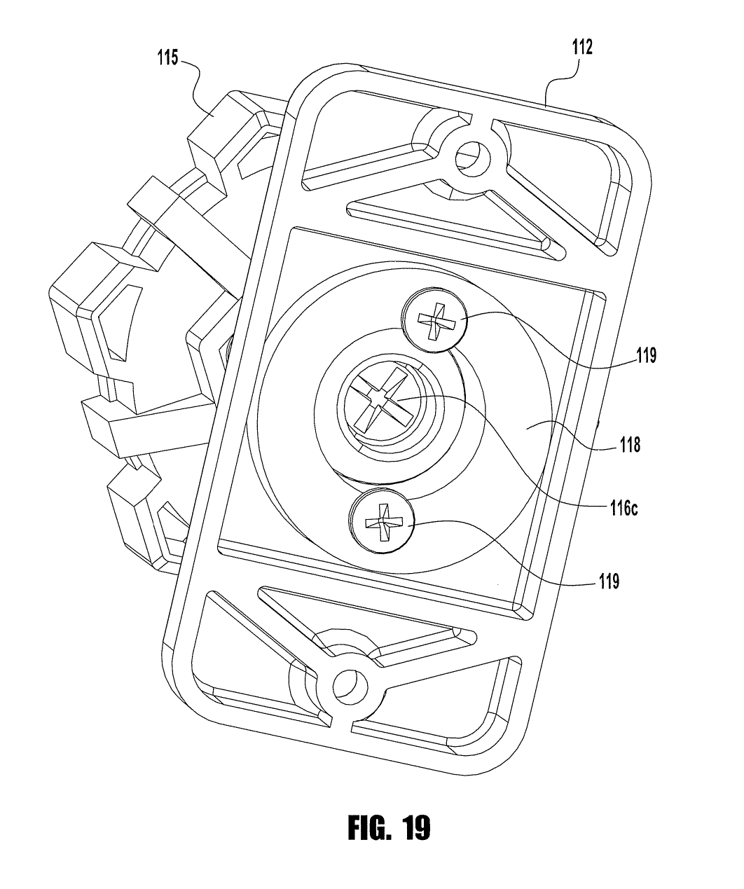

As shown in FIGS. 15-19, the stem portion 116b may be assembled with the housing of a lighting product 115, such as with the housing back 41a, 91a, of the lighting products of FIGS. 4 and 9. As such, the stem portion 116b may be threaded to engage a corresponding mounting hole on a lighting product. The exemplary flange 112 and ball retainer 118 include socket portions, as best seen in FIGS. 12 (for the ball retainer) and 13 (for the flange) which may be spherical, on which the outer surface of the ball portion 116a may ride or swivel to adjust the orientation of the stem portion 116b, and with it, the position of the lighting product to which the stem portion is assembled.

To secure the ball member 116 and lighting product 115 in a desired orientation, the flange 112 may be provided with a slot 112a across the socket portion of the flange. A fastener, such as a screw and bolt or a clamp, may be assembled with the slot 112a to constrict the slot and tighten the flexible portion of the flange 112 against the ball portion 116a to secure the ball member 116 against swiveling movement within the mounting arrangement 110. In the illustrated embodiment of FIGS. 11-19, a bolt 113 is inserted through aligned holes at the slot 112a, and a nut 114 is tightened to the bolt 113 to constrict the slot and clamp the ball portion 116a to prevent further adjustment of the lighting product 115.

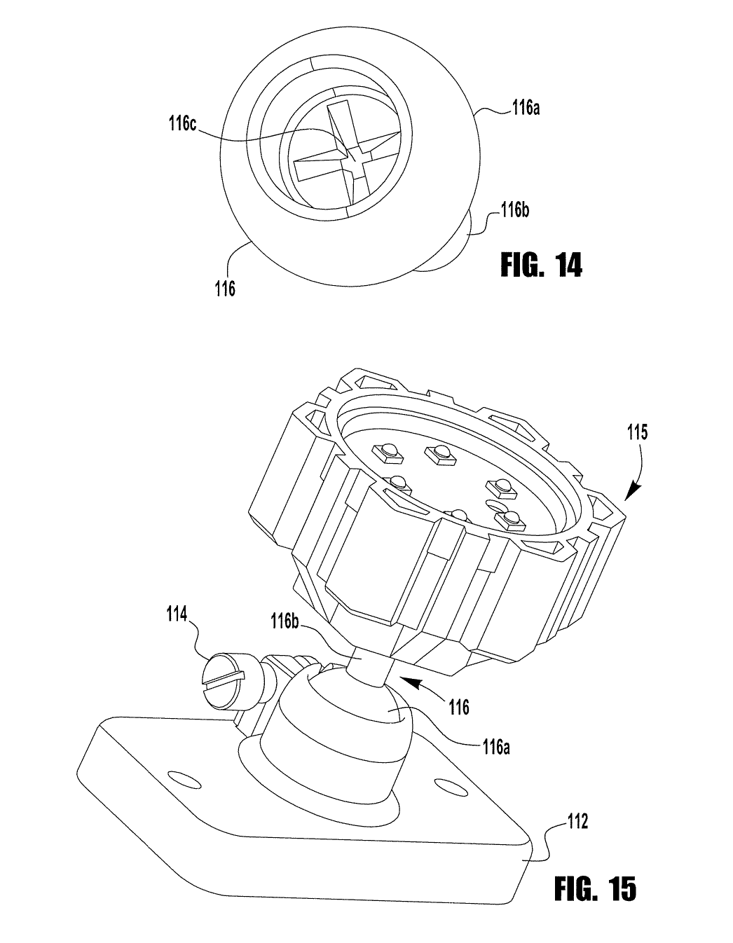

To assist in assembling or disassembling the exemplary ball member 116 from a lighting product 115, the ball member 116 may be provided with a tool interface to facilitate tightening or loosening of the ball member 116 from the lighting product 115. As shown in FIG. 14, an exemplary ball member 116 includes a slotted portion 116c configured to engage a Philips head screwdriver to tighten or loosen the threaded ball member 116.

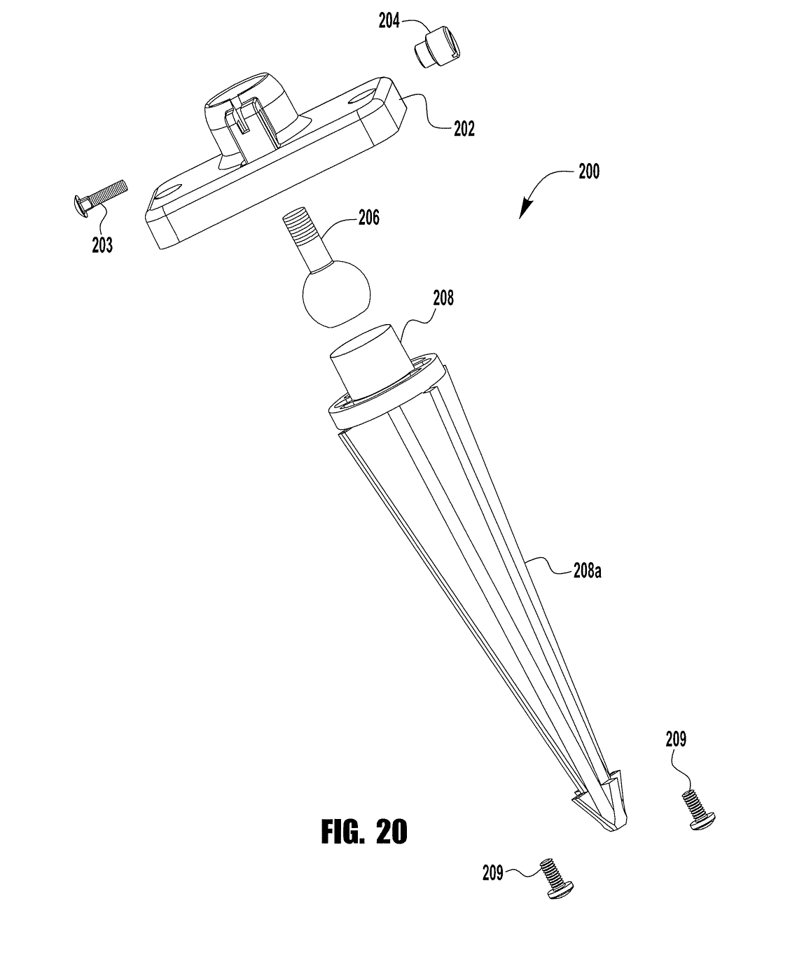

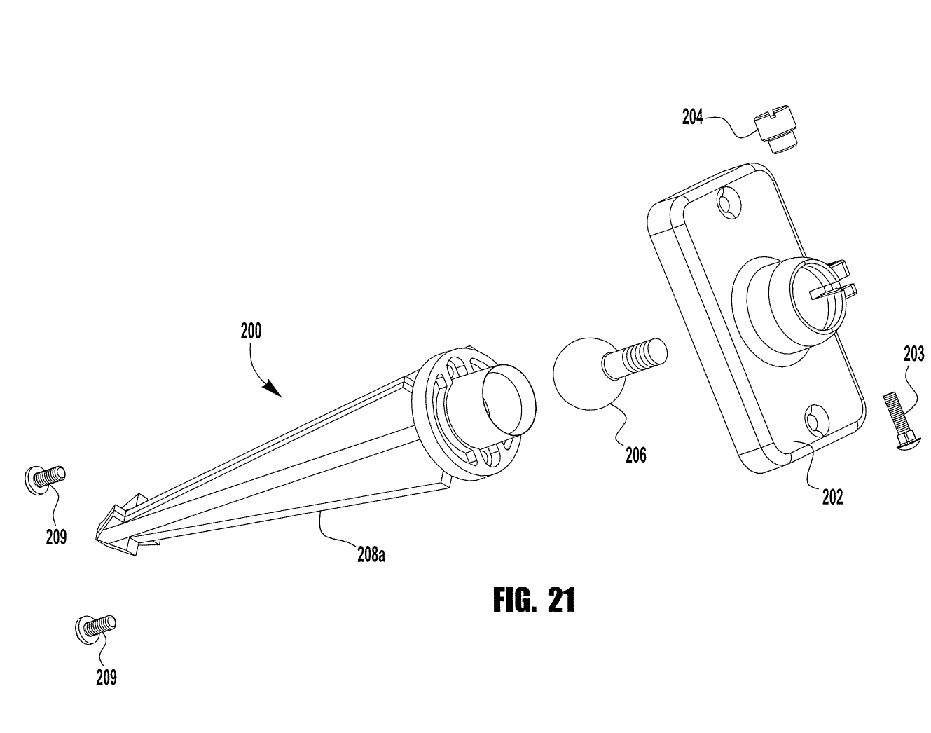

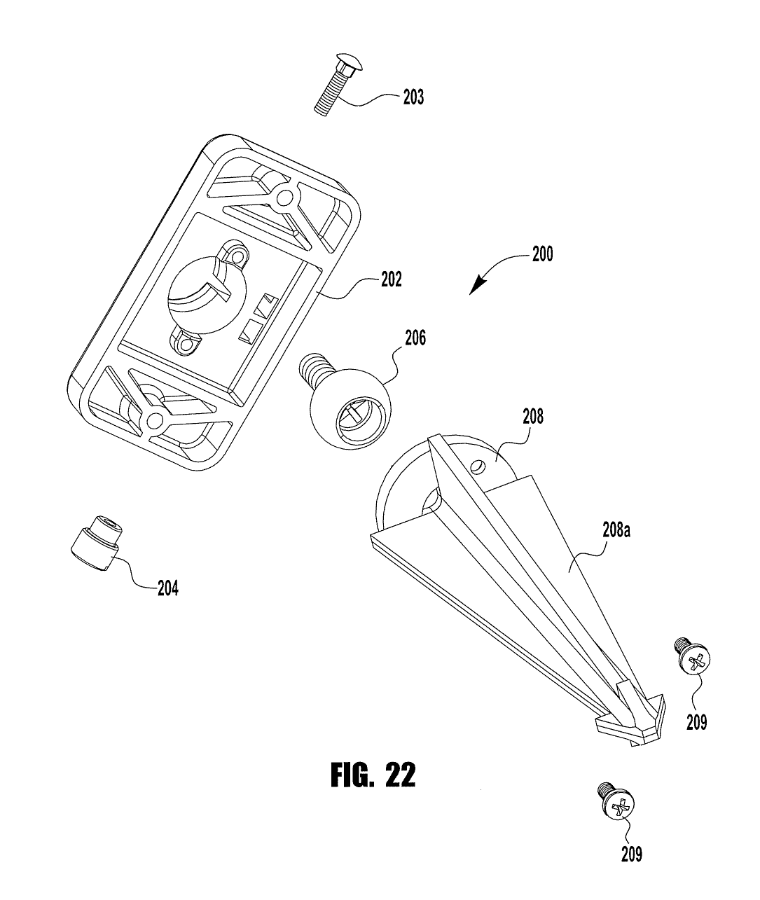

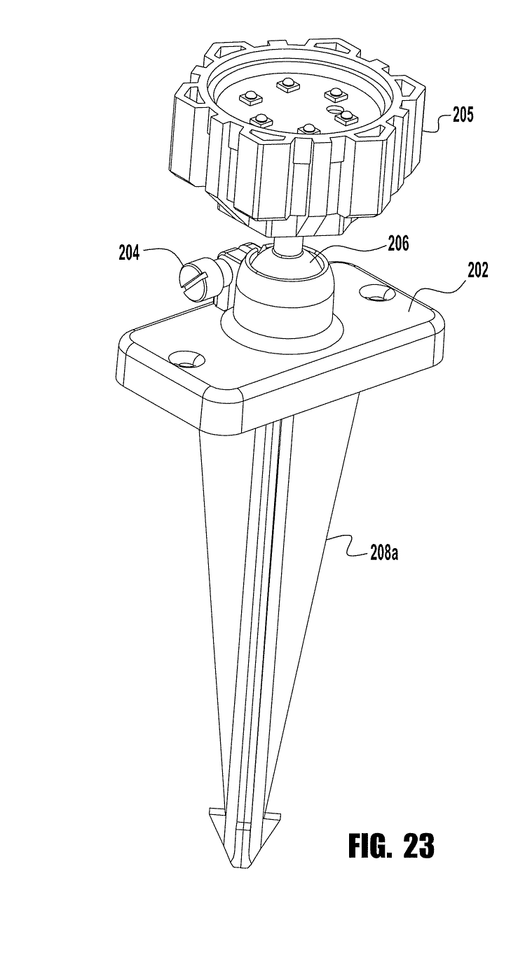

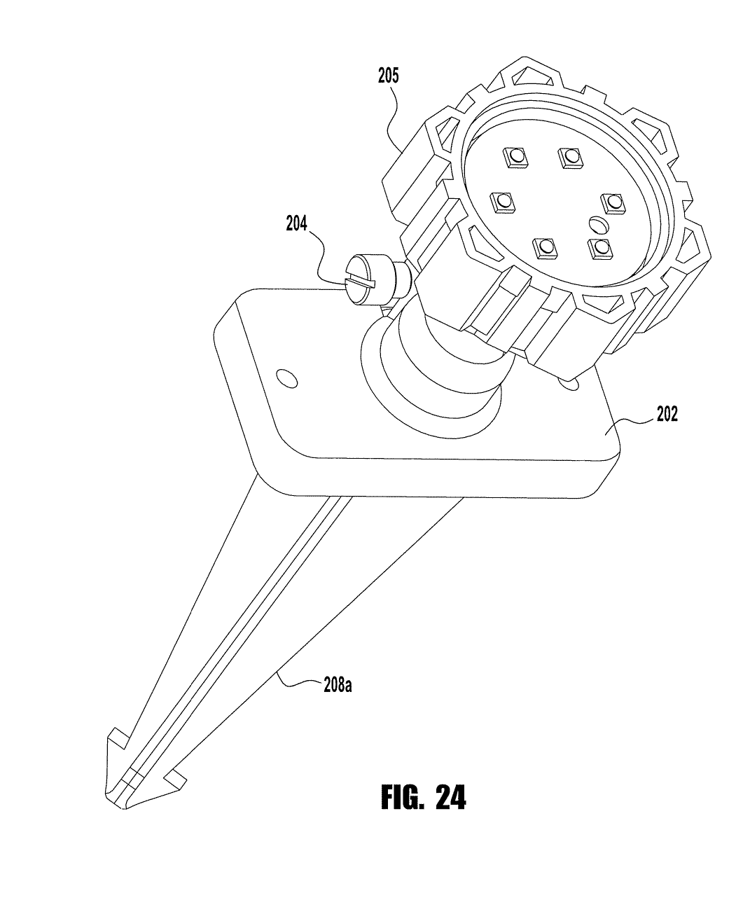

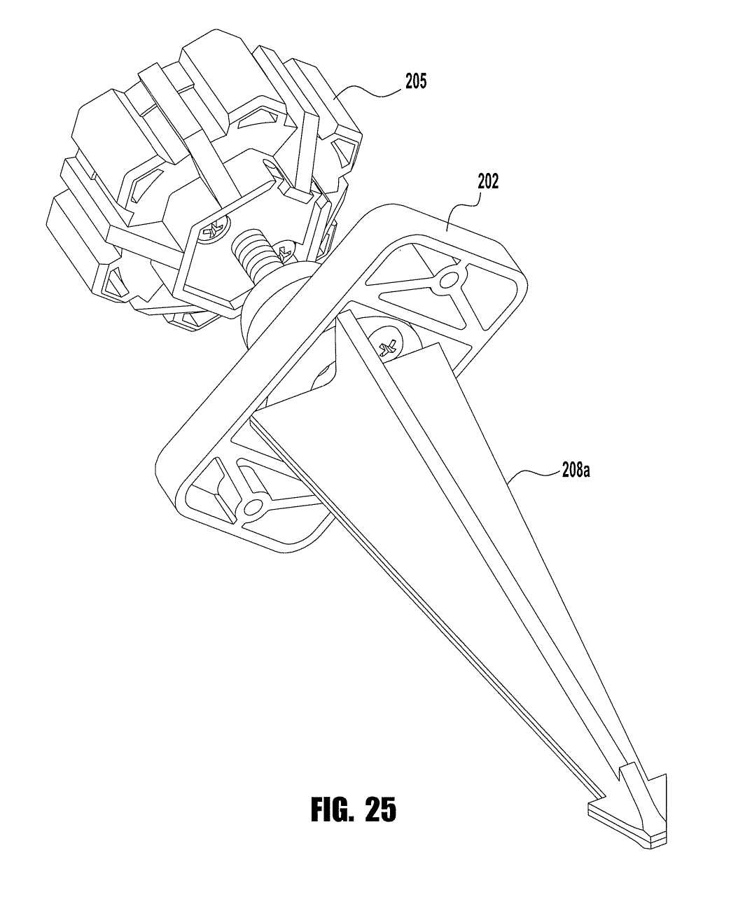

Many different types of mounting mechanisms may be provided with the mounting arrangement, such as, for example, mounting flanges, hooks, clamps, and stakes. Further, a mounting arrangement may be configured to include multiple mounting mechanisms. The exemplary mounting arrangement 200 of FIGS. 20-22 is similar to the mounting arrangement 110 of FIGS. 11-14, except that the arrangement 200 is further provided with a mounting stake 208a for affixing the lighting product 205 (see FIGS. 23-25) to the ground. The exemplary stake 208a may be integral with the ball carrier 208 as illustrated. In other embodiments (not shown), one or more stakes may be integral to a flange portion, or assembled with a flange or ball carrier, such as with fasteners. In still another embodiment (not shown), the mounting arrangement may be provided with a stake and without a flange portion; for example, the larger flange 202 may be replaced by a smaller upper ball retainer to be assembled with ball retainer 208.

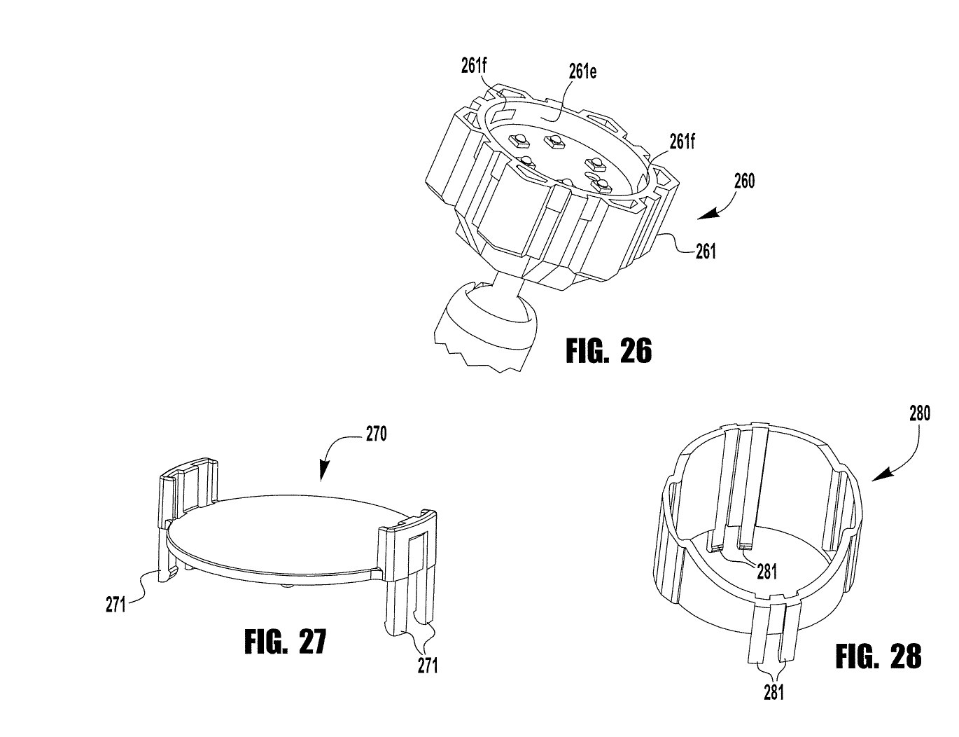

According to another aspect of the invention, a lighting product, such as the lighting products 40, 90 of FIGS. 4 and 9, may be provided with a housing adapted to engage various attachments to protect the light source or enhance or alter the illumination of the lighting product. In the illustrated embodiments of FIG. 26, a lighting product 260 includes a housing having an extended rim portion 261e adapted to engage one or more attachments, such as lenses 270 (see FIG. 27), cowls 280 (FIG. 28), filters (not shown), or other such accessories. The rim portion 261e may include slots 261f that engage prongs or tabs 271, 281 in a corresponding attachment 270, 280. Such attachments may provide further adaptability of a standard lighting product.

In some applications, mounting of a lighting fixture to a surface may be impractical or undesirable, such as, for example, where the surface is not conducive to the use of fasteners or other mounting means (e.g., a rock bed, or soft soil or sand), or where the use of fasteners would damage the surface (e.g., the waterproof liner of a swimming pool). However, a relatively lightweight lighting product, such as, for example, the LED lighting product 40 of FIG. 4, may be susceptible to movement from a desired location and/or orientation if the lighting product is not mounted or fastened in the desired location. For example, a lighting product intended for underwater use may be susceptible to movement resulting from: forces applied by electrical wiring supplying electricity to the lighting product (e.g., when the electrical wiring is being installed, or forces resulting from the wiring's tendency to twist or coil); from forces applied by moving water (e.g., a typical water current or waves in a pond or stream); or from forces applied by the buoyancy of the water in which the lighting product is submerged. In such applications, it may be desirable to provide the lighting fixture with a weighted component to provide additional stability, or, in the case of underwater applications, to counteract the lighting fixtures tendency to float in the water.

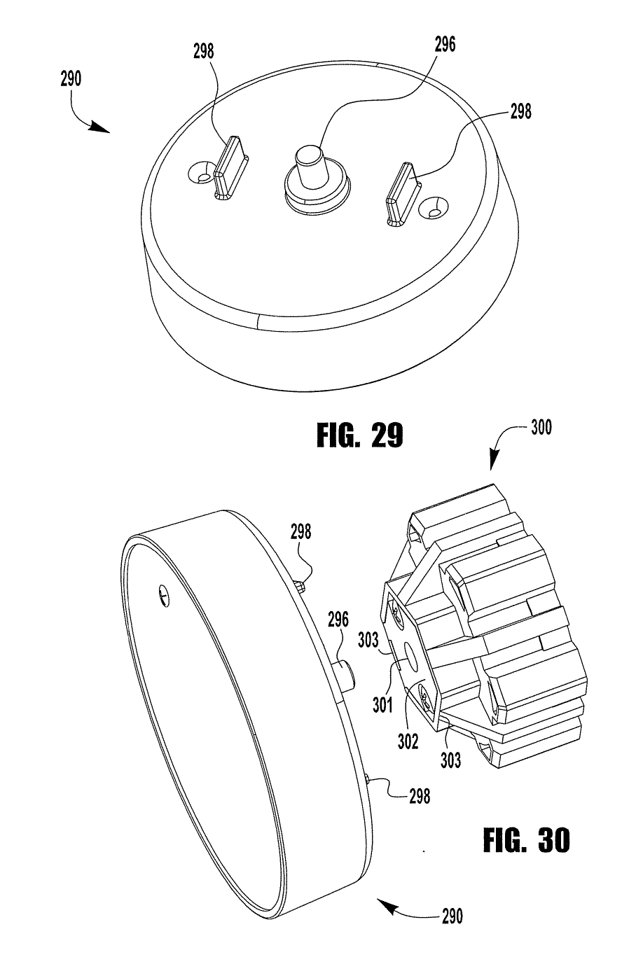

According to an inventive aspect of the present application, any of the lighting fixtures herein may be provided with one or more modular weighted members configured to directly or indirectly connect to the housing of the lighting fixture. FIGS. 29 and 30 illustrate an exemplary modular weighted member 290 configured to be selectively connected with a lighting product 300, which may (i.e., might, but need not) be consistent with the lighting assembly 90 of FIG. 9. The exemplary weighted member 290 includes a threaded stem portion or fastener 296 configured to be threaded into a corresponding threaded hole 301 in the lighting assembly 300. The weighted member 290 may further include ribs or other such projections 298 positioned to align with flats 303 on the housing back 302, as shown in FIG. 30. Additionally or alternatively, a weighted member may be configured for assembly with a mounting member, such as, for example, the positionable flange mount arrangement 110 of FIGS. 11-19, or with another lighting product attachment or accessory, such as, for example, another modular weighted member 290. As shown, the weighted member 290 may include threaded bores 291 for receiving fasteners to attach the weighted member to a mounting member or another accessory. The threaded bores 291 may, for example, be positioned to align with mounting holes on a mounting member (e.g., the mounting holes 111 on the flange 112 of the exemplary mounting arrangement 110 of FIGS. 11-19). While a weighted member may be constructed of any suitable materials, in the exemplary embodiment, the weighted member 290 includes an internal steel disc and a potted polycarbonate external casing, to provide a water tight enclosure for the internal steel disc.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. For example, the teachings herein, describing exemplary embodiments of lighting including light emitting diodes (LEDs), may be used with many different types of lighting products (fixtures or portables), such as, for example, incandescent, fluorescent, and halogen lighting products. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

What is claimed is:

1. A submersible LED lighting assembly, comprising:
a housing, comprising an outer wall portion defining an internal cavity;
a printed circuit board disposed in the internal cavity, the printed circuit board carrying at least one LED, wherein the at least one LED is thermally coupled to a heat sink carried by the housing, the heat sink being at least partially disposed in the cavity of the housing; and
a light-transmitting member covering at least a portion of the printed circuit board carrying the at least one LED and cooperating with at least the housing and the heat sink to seal the at least one LED to permit the submersible LED lighting assembly to be used while immersed in water; and
wherein the housing further comprises at least one opening permitting water to enter the opening and contact the heat sink.

2. The submersible LED lighting assembly of claim 1, wherein the outer wall portion comprises a plurality of projections generally arranged to form facets for securing the submersible LED lighting assembly underwater between objects.

3. The submersible LED lighting assembly of claim 2, wherein the housing further comprises a base extending from the outer wall portion, the base comprising a plurality of openings permitting water to enter the opening and contact the heat sink, and further wherein the outer wall portion and base of the housing are integrally molded from plastic material.

4. The submersible LED lighting assembly of claim 1, wherein the housing further comprises a base extending from the outer wall portion, the base comprising a plurality of openings permitting water to enter the opening and contact the heat sink, and further wherein the outer wall portion and base of the housing are integrally molded from plastic material.

5. An LED lighting assembly, comprising:
a housing, comprising an outer wall portion defining an internal cavity and a plurality of projections extending outwardly from an outer surface of the outer wall portion;
a printed circuit board disposed in the internal cavity, the printed circuit board carrying at least one LED, wherein the at least one LED is thermally coupled to the housing; and
a light-transmitting member covering at least a portion of the printed circuit board carrying the at least one LED; and
wherein at least a portion of the outer wall portion and the plurality of projections comprise a thermally conductive material to function as a heat sink to permit the LED lighting assembly to be used in a dry environment.

6. The LED lighting assembly of claim 5, wherein the light-transmitting member cooperates with at least the housing to seal the at least one LED to permit the LED lighting assembly to be used while immersed in water.

7. The LED lighting assembly of claim 6, wherein the plurality of projections are generally arranged to form facets for securing the LED lighting assembly underwater between objects.

8. The LED lighting assembly of claim 5, wherein the plurality of projections are generally arranged to form facets for securing the LED lighting assembly underwater between objects.

9. The LED lighting assembly of claim 5, wherein:
the plurality of projections comprise a plurality of fins extending radially outward from the outer surface of the outer wall portion, the plurality of fins being generally arranged to form facets for securing the LED lighting assembly underwater between objects, and wherein the facets are arranged such that a cross section of the housing appears as substantially a regular polygon having between 5 and 10 sides;
the at least one LED is thermally coupled to the housing via at least the printed circuit board; and
the light-transmitting member comprises at least one of a light-transmitting cover sealed against the housing with a water-tight seal to form a water-tight cavity proximate the at least one LED and a light-transmitting potting material covering the at least one LED.

10. A submersible LED lighting assembly, comprising:
at least one LED carried by a housing and thermally coupled to a heat sink carried by the housing to permit the submersible LED lighting assembly to be used in a dry environment; and
a water-tight light-transmitting member covering the at least one LED and cooperating with the housing to seal the at least one LED to permit the submersible LED lighting assembly to be used while immersed in water.

11. The submersible LED lighting assembly of claim 10, wherein the housing comprises an outer wall portion comprises a plurality of projections generally arranged to form facets for securing the submersible LED lighting assembly underwater between objects.

12. The submersible LED lighting assembly of claim 11, wherein the housing further comprises a base extending from the outer wall portion, the base comprising a plurality of openings permitting water to enter the opening and contact the heat sink, and further wherein the outer wall portion and base of the housing are integrally molded from plastic material.

13. The submersible LED lighting assembly of claim 10, wherein the housing comprises an outer wall portion and a base extending from the outer wall portion, the base comprising a plurality of openings permitting water to enter the opening and contact the heat sink, and further wherein the outer wall portion and base of the housing are integrally molded from plastic material.

14. A mounting accessory for a lighting product, the mounting accessory comprising:
a ball member comprising a stem portion for connecting with a base portion of the lighting product and a ball portion extending from the stem portion, the ball portion having a spherical outer surface;
a mounting member, adapted to be affixed to a mounting surface, the mounting member including an opening through which the stem portion extends, and a first spherical socket surface surrounding the opening and engaging the spherical outer surface of the ball member; and
a ball retaining member, assembled with the mounting member to secure the ball member therebetween, the ball retaining member including a second spherical socket surface engaging the spherical outer surface of the ball member;
wherein the ball portion and the first and second spherical socket surfaces provide a ball and socket connection for adjusting the orientation of the light source.

15. The mounting accessory of claim 14, wherein the mounting member comprises a mounting flange having at least one opening for receiving a mounting fastener therethrough.

16. The mounting accessory of claim 15, further comprising a weighted member removably attached to the mounting flange, the weighted member being capable of retaining a lighting product in a submerged underwater condition and supporting the lighting product in a selected orientation when the lighting product is assembled with the mounting accessory.

17. The mounting accessory of claim 16, wherein the weighted member is configured to prevent movement of a lighting product that is light enough to move when submerged under water in response to a force applied by one of (a) a force applied by electrical wires providing electricity to the lighting product; (b) a force applied by moving water in a pond; and (c) a force applied by the buoyancy of water, when the lighting product is assembled to the mounting accessory, is submerged in water, and is subjected to a corresponding one of the forces.

18. The mounting accessory of claim 15, wherein the mounting member comprises a mounting stake assembled with the mounting flange, the mounting stake being configured to be embedded in a ground surface.

19. The mounting accessory of claim 14, wherein the mounting member comprises a mounting stake configured to be embedded in a ground surface.

20. The mounting accessory of claim 14, further comprising a weighted member removably attached to the mounting member, the weighted member being capable of retaining a lighting product in a submerged underwater condition and supporting the lighting product in a selected orientation when the lighting product is assembled with the mounting accessory.

21. The mounting accessory of claim 20, wherein the weighted member is configured to prevent movement of a lighting product that is light enough to move when submerged under water in response to a force applied by one of (a) a force applied by electrical wires providing electricity to the lighting product; (b) a force applied by moving water in a pond; and (c) a force applied by the buoyancy of water, when the lighting product is assembled to the mounting accessory, is submerged in water, and is subjected to a corresponding one of the forces.

22. A submersible LED lighting assembly, comprising:
a housing, comprising an outer wall portion defining an internal cavity, the outer wall portion of the housing comprising a plurality of projections generally arranged to form facets for securing the submersible LED lighting assembly underwater between objects, and wherein the facets are arranged such that a cross section of the housing appears as substantially a regular polygon having between 5 and 10 sides;
a printed circuit board disposed in the internal cavity, the printed circuit board carrying at least one LED, wherein the at least one LED is thermally coupled to a heat sink via at least the printed circuit board, the heat sink being at least partially disposed in the cavity of the housing; and
a light-transmitting member covering at least a portion of the printed circuit board carrying the at least one LED and cooperating with at least the housing and the heat sink to seal the at least one LED to permit the submersible LED lighting assembly to be used while immersed in water, the light-transmitting member comprising at least one of a light-transmitting cover sealed against the housing with a water-tight seal to form a water-tight cavity proximate the at least one LED and a light-transmitting potting material covering the at least one LED; and
wherein the housing further comprises at least one opening permitting water to enter the opening and contact the heat sink;
further wherein the outer wall portion of the housing comprises a plurality of projections generally arranged to form facets for securing the submersible LED lighting assembly underwater between objects, and wherein the facets are arranged such that a cross section of the housing appears as substantially a regular polygon having between 5 and 10 sides.
